(19) United States
(12) Patent Application Publication
(10) Pub. No.: US 2008/0025150 A1
(43) Pub. Date: Jan. 31, 2008

(54) ELECTRONIC DEVICE WITH ROTATABLE COVER

(76) Inventors: Bonni Shevin Sandy, Morton Grove, IL (US); King Sau Chan, Tsuen Wan (HK)

Correspondence Address: PERKINS COIE LLP, POST OFFICE BOX 1208, SEATTLE, WA, 98111-1208, US

(21) Appl. No.: 11/550,928

(22) Filed: Oct. 19, 2006

(51) Int. Cl. G04B 47/00

(52) U.S. Cl. 368/10

(57) ABSTRACT

A portable electronic device has a plate pivotably attached to the housing. A cover assembly is pivotably attached to the plate. A cover plate is pivotably attached to the plate. A clip is provided on the cover plate. The cover plate can be pivoted to cover either side of the housing, or to position the clip into a desired orientation. The clip may also act as a stand, to allow the device to stand up on a flat surface.

### BACKGROUND OF THE INVENTION

Various portable electronic devices have a display, such as an LED display for providing various types of information to the user. For example, small portable digital clocks, stop watches, pedometers, video games, etc. have a display in or on a device housing. Some of these devices may also be provided with a stand or other element to allow the device to remain upright on a desk, table top, nightstand, etc. Other types of electronic devices may have a clip for holding the device onto a belt, waistband, pocket, backpack strap, etc. However, few, if any, of these types of devices are well adapted for carrying in a purse or pocket, while also suitable for clipping onto a belt, waistband, etc. and/or standing upright on a table top or other flat surface. Accordingly, a more adaptable electronic device is needed.

Some electronic devices may have a display on opposite sides of a housing. Alternatively, other electronic devices, for example, a clock, may have a display on one side and a usually flat opposite side suitable for mounting or holding a photograph, design logo, or other visual element (including a second display). With this type of device, using a clip or a stand, can result in various design compromises, since the device has two surfaces or areas which cannot be permanently obstructed. Accordingly, an electronic device having an improved supporting system is needed.

### SUMMARY OF THE INVENTION

An electronic device is provided within a housing. A cover is attached to the housing in a way that allows the cover to fit over or onto a first side of the housing, and through pivoting or rotational movement to also fit over or onto a second side of the housing. The second side of the housing may typically be opposite to the first side of the housing. The first side, or the second side, or both, may include an electronic display or other visual element.

The cover may include a clip for use while carrying the device. The clip may optionally also allow the device to stand up on a flat surface.

Other objects and features will become apparent from the following detailed description, which shows a single embodiment. However, the following description is provided as an example, and is not intended as a definition or as a limitation of the invention. The invention resides as well in subcombinations of the elements and steps described. The elements described in connection with one embodiment may also be used equivalently with other embodiments.

### BRIEF DESCRIPTION OF THE DRAWINGS

In the drawings, wherein the same reference number indicates the same element in each of the views:

FIG. 1 is a perspective view of the present electronic device.

FIG. 2 is a perspective view of the electronic device shown in FIG. 1, with the device standing upright on a flat surface.

FIG. 3 is a perspective view of the opposite side of the device as shown in FIG. 2.

FIG. 4 is a bottom view.

FIG. 5 is a left side view.

FIG. 6 is a front perspective view of the device shown in FIG. 1, with the cover assembly pivoted about ⅛ turn.

FIG. 7 is a rear perspective view of the device as shown in FIG. 6.

FIG. 8 is an alternative front perspective view of the device as shown in FIGS. 6 and 7.

FIG. 9 is a front perspective view of the device shown in FIG. 1 with the cover now rotated to a ¼ turn position.

FIG. 10 is a rear perspective view of the device as shown in FIG. 9.

### DETAILED DESCRIPTION OF THE DRAWINGS

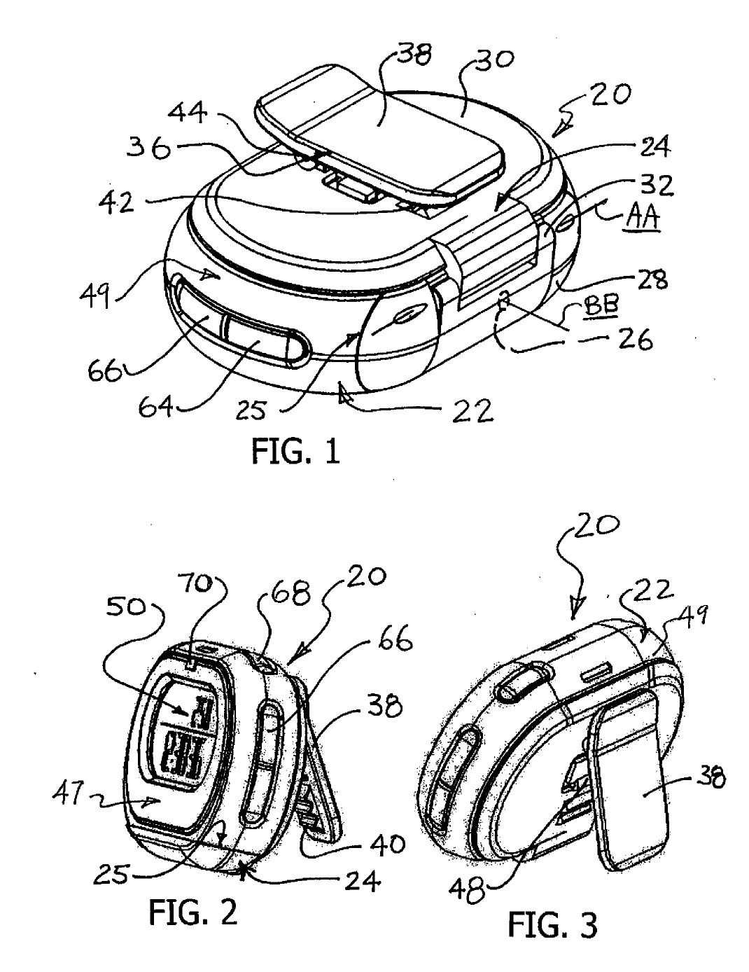

As shown in FIG. 1, a device 20 has a housing 22 and a cover assembly 24. The device 20 may be any type of electronic device having a display, such as a clock, pedometer, stopwatch, calculator, pager, cell phone, video game, GPS unit, walkie-talkie, e-mail/internet appliance, etc.

The housing 22, in the specific design shown, is generally oval-shaped, with a generally flat front surface 47, a generally flat back surface 52, and rounded sides 49. The housing 22 may have other shapes and configurations, including generally round, square, or other geometric shapes. The housing 22 may also be more 3-dimensional, having a more generally spherical or cubic configuration.

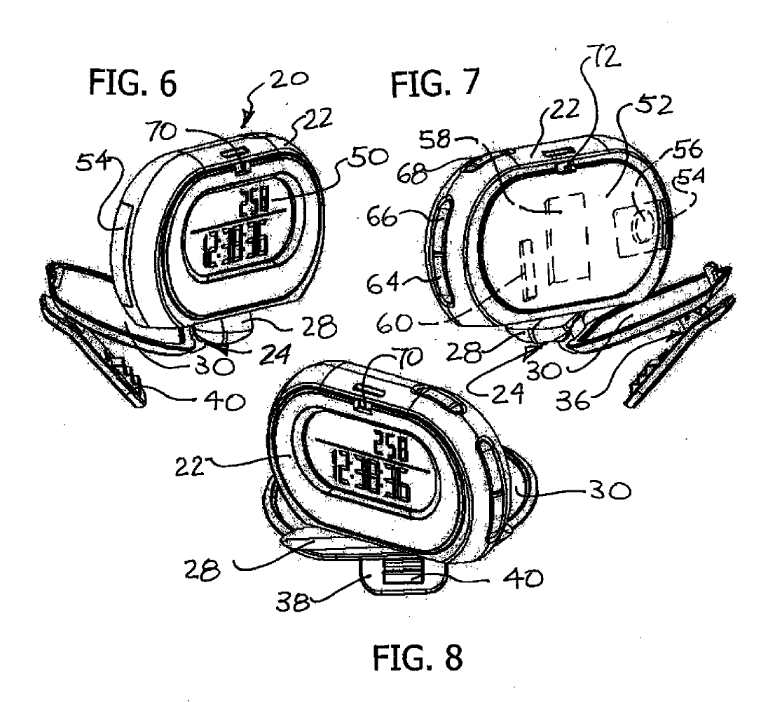

A cover assembly 24 is attached to the housing 22. The cover assembly 24 includes a pivot or base plate 28 attached to the housing 22 by a pivot joint or connection 26. The pivot connection 26 may be formed by a pin on the plate 28, extending into and captive within the housing 22. The outer surfaces of the pivot plate 28 may be contoured to match the corresponding ends 49 of the housing 22. Accordingly, as shown in FIG. 1, the pivot plate 28 initially appears to be part of, or continuous with, the housing 22. However, referring also momentarily to FIG. 6, the pivot plate 28 is separated from the housing 22 by a separation line 25. The pivot plate 28 can pivot or rotate about axis BB by applying nominal hand force.

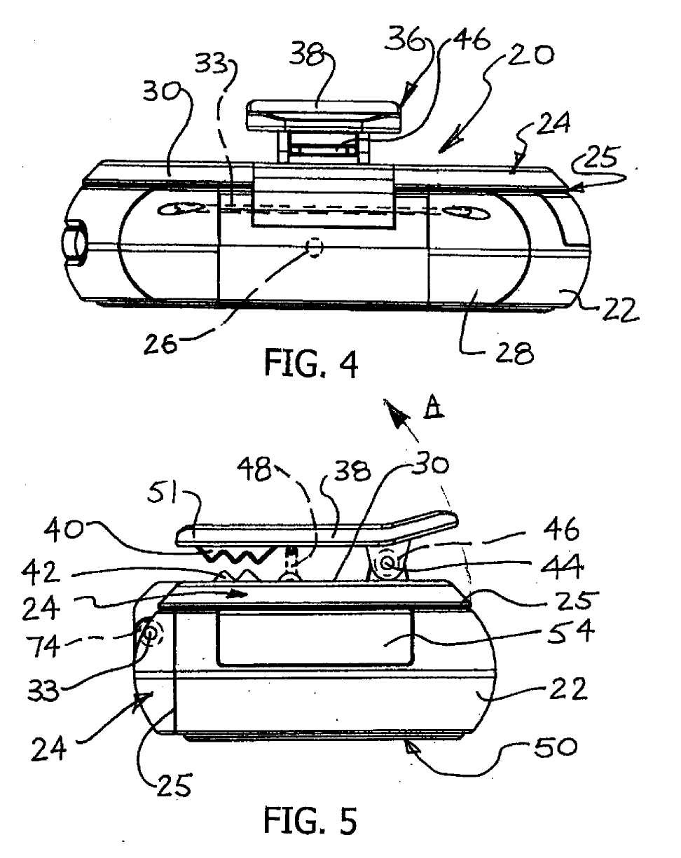

Referring to FIGS. 1 and 4, a cover plate 30 is attached to the pivot plate 28 by a cover plate pivot joint 32. The cover plate pivot joint 32 may be formed with a pin 33 extending through both the pivot plate 28 and the cover plate 30. A clip assembly 36 is advantageously provided on the cover plate 30. The clip assembly 36 includes a clip plate 38 attached to the cover plate 30 by a clip pivot joint 44. Referring to FIG. 5, a spring element 46 urges the outer or lower end 51 of the clip plate 38 against the cover plate 30. Clip teeth 40 may be provided at the lower end 51 of the clip plate 38, positioned to engage or mesh with corresponding plate teeth 42 on the cover plate 30. Referring still to FIG. 5, a clip spacer 48 is advantageously pivotably attached to the cover plate 30 and moveable into an extended position, as shown in dotted lines in FIG. 5, for holding the lower end 51 of the clip plate 38 away from the cover plate 30, against the force exerted by the spring element 46. With the clip spacer 48 in this position, the device 20 can be placed into an upright position on a flat surface as shown in FIGS. 2 and 3. Accordingly, use of the clip assembly 36 and clip spacer 48 as shown and described, allows the device 20 to be used on a table, desk, etc.

Referring to FIGS. 2, 6, and 7, a display, such as an LED display 50 may be provided on the front surface 47 of the device 20. Another display may optionally similarly be provided on the back surface 52 shown in FIG. 7. Alternatively, a photograph, logo, or other visual element, printed or electronically generated, may be provided on the back surface 52. The specific design shown in the drawings illustrates the device 20 as a clock/pedometer. In this particular design, the display 50 is an LCD display having upper digits indicating number of steps or paces, and lower digits indicating time, elapsed time, or other similar function. In a clock/pedometer device 20, one or more batteries 56 are contained within a battery cover or holder 54, as shown in FIG. 7. An electronic circuit 58 is linked to the battery 56 and to the display 50. Switches or controls on the housing 22, such as a set button 64, a mode button 66, and a start/stop button 68, are also linked to the electronic circuit 58. A motion sensor 60 for detecting walking movement (such as a pendulum, accelerometer, etc.) is also linked to the circuit 68.

The cover assembly 24 is rotatable about axis BB via the pivot or rotation joint 26. This allows the clip assembly 36 to be moved into various positions, generally independent of the orientation of the display 50. Accordingly, by rotating the cover assembly 24, the device 20 may be clipped onto a supporting surface running at an irregular angle, using the clip assembly 36. In addition, the cover plate 30 may be moved to cover either the front surface 47 or the rear surface 52 of the device 20.

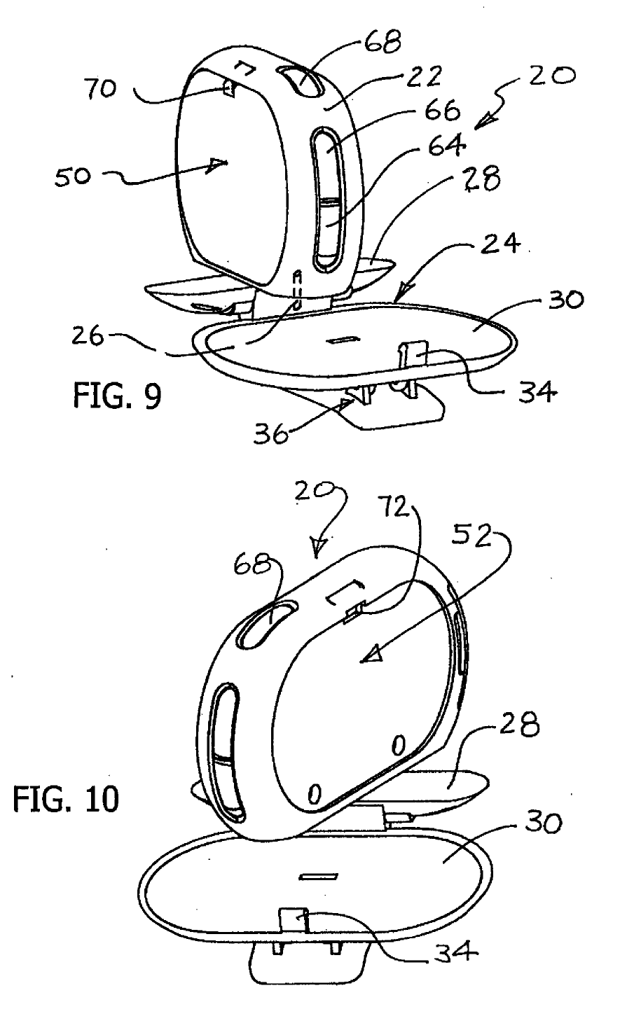

FIGS. 6-8 show initial movement of the cover assembly 24. The upper (or free) end of the cover plate 30 is pivoted away from the housing 22 about the cover plate pivot joint 32, in the direction of the arrow A in FIG. 5. With the cover plate 30 now oriented in a plane generally perpendicular to the plane of the housing 22 (or to the flat front surface 47), the pivot plate 28 is pivoted about axis BB via the pivot joint 26. FIGS. 6-8 show the cover assembly 24 pivoted about ⅛ turn. This pivoting movement of the cover assembly 24 continues until completed at ½ turn. FIGS. 9 and 10 show the cover assembly 24 at another intermediate position, about halfway between the position of the cover assembly shown in FIG. 1, and the position of the cover assembly 24 after rotated ½ turn. Referring to FIGS. 9 and 10, with the cover assembly 24 rotated ½ turn, the cover plate 30 may be again pivoted about axis AA and the cover plate pivot joint 32, to have the cover plate 30 cover the back surface 52 of the housing 22. A latch 34 may be provided on the cover plate 30 to engage a slot 70 or 72 in the housing 22, as shown in FIG. 10, or vice versa.

By movement of the cover assembly 24 as described, the cover plate 30 may cover the front surface 47 or the back surface 52 of the housing 22. A second spring element 74, shown in FIG. 5, may optionally be provided at the cover plate pivot joint 32, to bias the cover plate 30 into either an open or closed position.

Although the pivot plate 28 is shown as matching, or completing the overall shape of the housing 22, other forms of pivot plate 28 may also be used. The terms front, back, top, bottom, etc. as used here may be interchanged, as they describe orientations not essential to the invention.

The axis AA is generally perpendicular, or nearly perpendicular to the axis BB. Depending on the size and shape of the housing 22 and the cover plate 30, the cover assembly 24 may be pivoted with the cover plate 30 at less than a 90 degree angle relative to the plane of the housing 22.

Thus, a novel electronic device has been shown and described. Various change and substitutions may of course be made without departing from the spirit and scope of the invention. The invention, therefore, should not be limited, except to the following claims, and their equivalents.

1. A portable electronic device comprising:
a housing;
a pivot plate;
a first pivot connection attaching the pivot plate to the housing, with the pivot plate pivotable about a first axis;
a cover assembly; and
a second pivot connection attaching the cover assembly to the pivot plate, with the cover assembly pivotable about a second axis substantially perpendicular to the first axis.

2. The portable electronic device of claim 1 with the cover assembly comprising a cover plate, and further including a clip on the cover plate.

3. The portable electronic device of claim 2 with the clip including a clip plate, and a third pivot connection pivotably attaching the clip plate to the cover plate, and further including a spring element biasing a first end of the clip plate into contact with the cover plate.

4. The portable electronic device of claim 3 with the clip plate pivotable about a third axis parallel to the second axis.

5. The portable electronic device of claim 3 further comprising a clip spacer associated with the clip plate, and with the clip spacer moveable from an extended position, where the clip spacer holds the first end of the clip plate away from the cover against the force of the spring element, to a retracted position where the first end of the clip plate contacts the cover plate.

6. The portable electronic device of claim 1 with the housing further comprising a first side and a second side, and with the cover moveable to cover the first side or the second side.

7. The portable electronic device of claim 6 further comprising an electronic display on the first side.

8. The portable electronic device of claim 7 further comprising a pedometer assembly in the housing, including a motion sensor, and a circuit linked to the motion sensor and to the electronic display.

9. The portable electronic device of claim 7 further comprising a visual element on the second side of the housing, with the visual element comprising an electronic display or printed media.

10. The portable electronic device of claim 1 with the second pivot connection attached to a first end of the cover, and further comprising a latch for securing a second end of the cover to the housing.

11. A combination clock and pedometer, comprising:
a housing having a first side and a second side opposite from the first side, and a top surface and a bottom surface;
an electronic display on the first side;
a pivot plate pivotally attached to the bottom surface of the housing;
a cover plate pivotally attached to the pivot plate; and
a clip on the cover plate.

12. The combination clock and pedometer of claim 11 further comprising a latch for holding an upper end of the cover plate onto the housing.

13. The combination clock and pedometer of claim 11 further comprising clip holding means for holding an end of the clip away from the cover plate, to allow the clock and pedometer to stand up on a flat surface.

14. The combination clock and pedometer of claim 11 with the pivot plate having a generally flat top surface and a curved bottom surface, and with the pivot plate attached to the housing via a pivot joint located substantially at a center position of the housing.

15. The combination clock and pedometer of claim 11 wherein the first and second sides of the housing, and the cover plate, are substantially flat.

16. The combination clock and pedometer of claim 11 further comprising a clock and pedometer circuit within the housing linked to the display and to at least one battery within the housing.

17. The combination clock and pedometer of claim 16 further comprising one or more control switches on the housing between the first and second sides of the housing, with the switches linked to the circuit.

18. A method for uncovering a first surface and covering a second surface of a portable electronic device, comprising the steps of:
(a) pivoting a first end of a cover plate away from the first surface of the portable electronic device, about a first axis;
(b) pivoting the cover plate about a second axis substantially perpendicular to the first axis; and
(c) pivoting the first end of the cover plate towards the second surface of the portable electronic device, about a third axis substantially parallel to the first axis.

19. The method of claim 18 wherein step (a) is performed by pivoting the cover plate by about ½ turn.

20. The method of claim 18 wherein steps (a) and (c) are performed by pivoting the cover plate by about ¼ turn.
